(19) United States
(12) Patent Application Publication
(10) Pub. No.: US 2020/0383038 A1
(43) Pub. Date: Dec. 3, 2020

(54) WIRELESS COMMUNICATION DEVICE, NETWORK NODE, METHODS AND COMPUTER PROGRAMS

(71) Applicant: Telefonaktiebolaget LM Ericsson (publ), Stockholm (SE)

(72) Inventors: David SUGIRTHARAJ, Lund (SE); Christian BERGLJUNG, Lund (SE); Yusheng LIU, Lund (SE); Emma WITTENMARK, Lund (SE); Chunhui ZHANG, Stockholm (SE)

(21) Appl. No.: 16/604,602

(22) PCT Filed: Apr. 12, 2018
(86) PCT No.: PCT/EP2018/059367

§ 371 Date: Oct. 11, 2019

Related U.S. Application Data
(60) Provisional application No. 62/484,573, filed on Apr. 12, 2017.

(51) Int. Cl. H04W 48/16; H04L 5/00; H04W 72/04; H04W 8/18; H04W 24/10

(52) U.S. Cl. CPC H04W 48/16; H04L 5/001; H04W 24/10; H04W 8/183; H04W 72/0453

(57) ABSTRACT

Methods for a wireless communication device and network node are provided. A method is performed by a wireless communication device arranged to operate in a cellular communication system. Information about a carrier frequency to perform measurements on is acquired, and a check made whether the carrier frequency belongs to a set of frequencies on which information is kept by the wireless communication device in a searchable frequency set. If the carrier frequency belongs to the set, the wireless communication device carries on with measurements. If the carrier frequency does not belong to the set, the wireless communication device proceeds with adding the information about the carrier frequency to the set.

### TECHNICAL FIELD

The present disclosure generally relates to methods for a wireless communication device and for a network node, such wireless communication device and network node, and computer programs for implementing the methods in the respective entity.

### BACKGROUND

The 3^{rd} Generation Partnership Project, 3GPP, work on “Licensed-Assisted Access” (LAA) intends to allow Long Term Evolution, LTE, equipment to also operate in the unlicensed radio spectrum. Candidate bands for LTE operation in the unlicensed spectrum include 5 GHz, 3.5 GHz, etc. The unlicensed spectrum is used as a complement to the licensed spectrum or allows completely standalone operation.

For the case of unlicensed spectrum used as a complement to the licensed spectrum, devices connect in the licensed spectrum (primary cell, PCell) and use carrier aggregation to benefit from additional transmission capacity in the unlicensed spectrum (secondary cell, SCell). Carrier aggregation (CA) framework allows to aggregate two or more carriers with the condition that at least one carrier (or frequency channel) is in the licensed spectrum and at least one carrier is in the unlicensed spectrum. In the standalone (or completely unlicensed spectrum) mode of operation, one or more carriers are selected solely in the unlicensed spectrum.

Regulatory requirements, however, may not permit transmissions in the unlicensed spectrum without prior channel sensing, transmission power limitations or imposed maximum channel occupancy time. Since the unlicensed spectrum must be shared with other radios of similar or dissimilar wireless technologies, a so-called listen-before-talk (LBT) method needs to be applied. LBT involves sensing the medium for a pre-defined minimum amount of time and backing off if the channel is busy. Due to the centralized coordination and dependency of terminal devices on the base-station (eNB) for channel access in LTE operation and imposed LBT regulations, LTE uplink (UL) performance is especially hampered. UL transmission is becoming more and more important with user-centric applications and the need for pushing data to cloud.

Today, the unlicensed 5 GHz spectrum is mainly used by equipment implementing the IEEE 802.11 Wireless Local Area Network (WLAN) standard. This standard is known under its marketing brand “Wi-Fi” and allows completely standalone operation in the unlicensed spectrum. Unlike the case in LTE, Wi-Fi terminals can asynchronously access the medium and thus show better UL performance characteristics especially in congested network conditions.

A typical cell search procedure for a UE operating in an LTE system is typically performed as follows:

1. RSSI scan involves the UE searching sequentially through the frequencies in the frequency band and measuring the RSSI. The RSSI values are measured at the centre frequency across the interesting bandwidths. The end result is a list of frequencies with the RSSI measurements. The frequencies with the strongest RSSI values are further processed.

2. Acquire symbol level synchronization and determine the physical cell identity of the cell with the PSS and SSS signals.

3. Acquire frame timing to the cell by decoding the master information block (MIB).

4. Receive and decode cell system information.

5. Access the cell

When performing the RSSI scan in the licensed band, the resulting list of frequencies to further perform cell search on is reliable and relatively small for most bands in comparison to a corresponding result on the unlicensed bands. The results in unlicensed also contain interferers from other technologies or networks. Unlicensed bands are also much wider than their licensed counterparts. The 3.5 GHz, as illustrated in FIG. 1, and the 5.0 GHz bands are 150 MHz and 600 MHZ wide respectively.

LTE based technologies currently use frequency rasters that are 100 kHz apart. Using a 100 kHz raster across 600 MHz bands leads to an excessively larger amounts of frequencies to scan. From the specification point of view, LTE limits the number of valid frequencies on the 5.0 GHz band. The reason for this is to align with Wi-Fi for co-existence purposes. This results in basic raster points which are 20 MHz apart. Furthermore, in order to preserve the orthogonality of the 15 kHz subcarrier and 100 kHz raster, the channel spacing between the different component carrier for continuous carrier aggregation need to be integer of the 300 kHz. Several offsets (4) are also provisioned to account for carrier separation requirements for carrier aggregation.

In MulteFire, the valid frequencies need to be limited in order to reduce UE cell search time. The cell search time would intrinsically take longer times considering DRS signals are sparser with longer periodicity and experience LBT blocking. Reducing the cell search time during power on or background cell search will give benefit of improving user experience. Similar issues are believed to occur for other systems taking benefit of unlicensed spectrum.

The problem with limiting the set of valid frequencies is seen on the UE side. If a UE is designed to search a limited set of frequencies, there is an issue of being forward compatible. As new technologies are being introduced into bands, new frequencies are introduced which the older UEs are not aware of. So this becomes a classic trade-off between UE search time/power consumption and being future proof. Other issues from lacking flexibility may also occur.

For example, UE has the capability reporting to network indicate which release it supports hence network knows which EARFCN set UE can support in cell search phase. However, it is not likely for a release 8 UE to support release 10 new EARFCN. As mentioned above, the new EARFCN will be very likely to be added in new release to cope with congested shared channel with new/old unlicensed technology to avoid the interference and better utilized the unlicensed band. The old release UE cannot search the newly added EARFCN which means the network need to use the old EARFCN set at whole network which limited the network flexibility when operating in unlicensed band. Other examples are when unlicensed bands are not really the same for different regions of the world, and not all UEs have pre-stored information for all regions and when a UE is brought to such another region, there may be an issue.

### SUMMARY

The disclosure is based on the understanding that the flexibility inherent in coming communication systems will require flexible solutions for managing operation of the wireless communication devices. The inventors have found that by providing an approach for keeping a frequency set used for performing measurements for finding channels to communicate on, the flexibility of the wireless communication device, and thus for the whole communication system, is increased.

According to a first aspect, there is provided a method performed by a wireless communication device arranged to operate in a cellular communication system. The method comprises acquiring information about a carrier frequency to perform measurements on, and checking whether the carrier frequency belongs to a set of frequencies on which information is kept by the wireless communication device in a searchable frequency set. If the carrier frequency belongs to the set, the wireless communication device carries on with measurements. If the carrier frequency does not belong to the set, the wireless communication device proceeds with adding the information about the carrier frequency to the set.

The method may comprise trying to make measurements on the carrier frequency, wherein the wireless communication device only adds the information about the carrier frequency to the set when successful measurements are feasible on the carrier frequency.

The information about the carrier frequency may comprise an absolute radio-frequency channel number, ARFCN, according to a reference of the cellular communication system. For example, the cellular communication system may be a 3^{rd} Generation Partnership Project, 3GPP, Long Term Evolution, LTE, system, or a system based on thereon, operating in licensed, unlicensed or shared spectrum, applying enhanced universal terrestrial radio access, EUTRA, wherein the ARFCN is an EUTRA ARFCN, EARFCN, for a radio band currently applied.

The method may comprise evaluating whether the information about the carrier frequency is sufficient for the wireless communication device to determine a physical frequency corresponding to the carrier frequency, wherein the wireless communication device interacts through signalling with a serving network node of the cellular communication system to acquire further information about the carrier frequency if the physical frequency cannot be determined.

The searchable frequency set may be kept in a list or database in the wireless communication device or a subscriber identity module associated with the wireless communication device, which list or database is further populated upon adding the information about the carrier frequency.

The acquiring of the information about the carrier frequency may include receiving signalling comprising the information from a serving network node of the cellular communication system.

The set of frequencies may comprise one or more subsets of frequencies, where the respective frequencies belong to a subset based on at least one of operator information, location information, positioning, surrounding radio environment and UE connection history, and wherein the subset to be prioritised for performing the measurements may be based on corresponding actual circumstances as the division among the subsets.

According to a second aspect, there is provided a computer program comprising instructions which, when executed on a processor of a wireless communication apparatus, causes the wireless communication apparatus to perform the method according to the first aspect.

According to a third aspect, there is provided a wireless communication device arranged to operate in a cellular communication system, wherein the wireless transceiver device comprises a transceiver, a processor and a memory and is arranged to perform the method according to the first aspect.

According to a fourth aspect, there is a method performed by a network node arranged to operate in a cellular communication system. The method comprises transmitting information about a carrier frequency to a wireless communication device on which the wireless communication device is intended to perform measurements on, and either receiving a measurement report related to the carrier frequency from the wireless communication device, or receiving a request from the wireless communication device for further information about the carrier frequency.

The information about the carrier frequency may comprise an absolute radio-frequency channel number, ARFCN, according to a reference of the cellular communication system. For example, the cellular communication system may be a 3^{rd} Generation Partnership Project, 3GPP, Long Term Evolution, LTE, system, or a system based on thereon, operating in licensed, unlicensed or shared spectrum, applying enhanced universal terrestrial radio access, EUTRA, wherein the ARFCN is an EUTRA ARFCN, EARFCN, for a radio band currently applied.

According to a fifth aspect, there is provided a computer program comprising instructions which, when executed on a processor of a network node, causes the network node to perform the method according to the fourth aspect.

According to a sixth aspect, there is provided a network node arranged to operate in a cellular communication system, the network node comprising a transceiver, a processor and a memory and being arranged to perform the method according to the fourth aspect.

### BRIEF DESCRIPTION OF THE DRAWINGS

The above, as well as additional objects, features and advantages of the present disclosure, will be better understood through the following illustrative and non-limiting detailed description of preferred embodiments of the present disclosure, with reference to the appended drawings.

FIG. 1 schematically illustrates resources at an exemplary unlicensed frequency band.

FIG. 2 is a flow chart illustrating a method for a wireless communication device according to an embodiment.

FIG. 3 is a block diagram schematically illustrating a wireless communication device according to an embodiment.

FIG. 4 schematically illustrates a computer-readable medium and a processing device.

FIG. 5 illustrates parts of a cellular communication network including network nodes and a wireless device.

FIG. 6 is a flow chart schematically illustrating a method for a network node according to an embodiment.

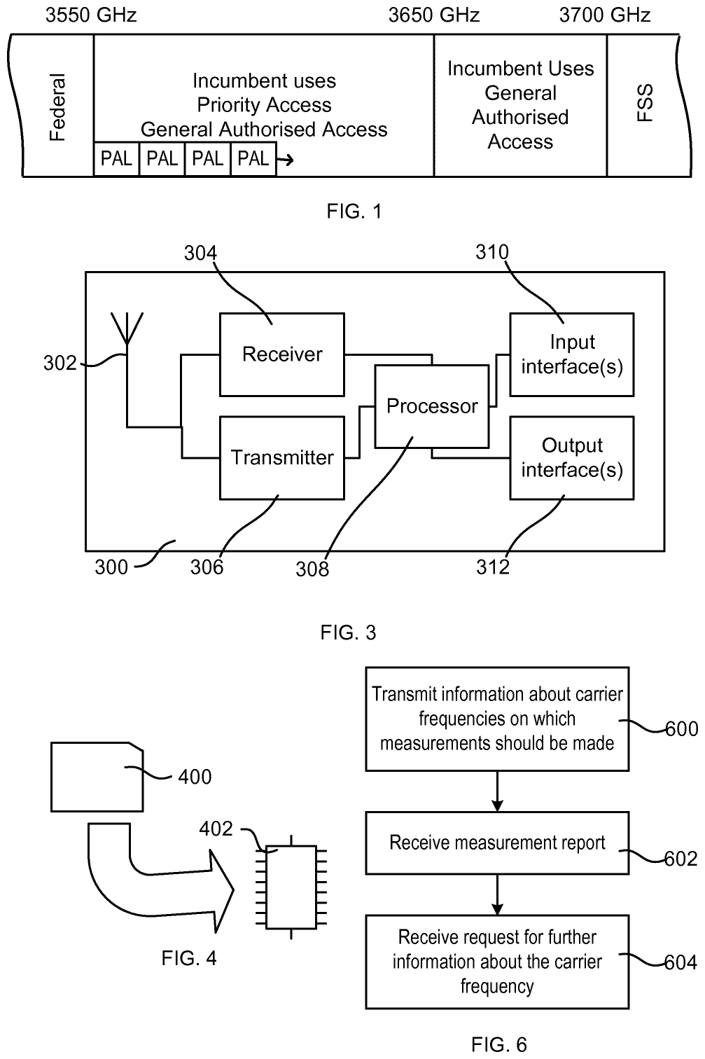

### DETAILED DESCRIPTION

LTE (E-UTRA) is specified for operation in frequency (operating) bands defined in terms of their frequency arrangement in the spectrum. For Frequency Division Duplex (FDD) a frequency range designated for uplink (UL) communications (mobile to base station) is paired with another corresponding frequency range designated for downlink (DL) communications (base-to-mobile), whereas for Time Division Duplex a single frequency range is designated for time-multiplexed uplink and downlink communications. There are currently more than 30 operating bands specified for LTE operation, each of which is designated with a unique band number; e.g. Band 1 is defined for FDD operation in the frequency ranges 1920-1980 MHz (UL) and 2110-2170 MHz (DL).

Each operating band supports channels (carriers) of various bandwidths; for LTE these bandwidths range from 1.4 MHz to 20 MHz. For each band a channel can assigned within the UL and DL frequency range—the same for TDD—at a carrier (centre) frequency that is mapped from a channel number denoted EARFCN (E-UTRA Absolute Radio Frequency Channel Number). The said carrier frequency is taken from a specified set of carrier frequencies (the channel raster) corresponding in turn to a set of EARFCN. There is a unique one-to-one correspondence between the set of EARFCN and an operating band of a certain band number. For FDD there are two sets of EARFCN, a set of DL EARFCN and a set of UL EARFCN. For TDD, DL EARFCN=UL EARFCN. The operating band(s) currently specified for unlicensed operation are specified for TDD operation.

The EARFCNs relevant for operating bands used in a radio network deployment are obtained by the mobiles as part of the cell-search procedure. When a mobile has found an LTE channel (and thus its DL centre frequency) following a cell search, the band number is obtained from system information. Using the band number and the know DL carrier frequency the appropriate DL EARFCN and UL EARFCN can be found (unique mapping from the band number). Once the UL EARFCN is known, uplink transmissions in a band can commence.

EARFCNs are also used in mobility information for e.g. inter-frequency handovers between cells of different carrier frequencies in a network.

The concept of channel numbers for defining carrier frequencies (the channel/band raster) is also used for other systems: for UMTS (UTRA) the corresponding notion is UARFCN and for GSM (ARFCN). The embodiments described are described in terms of EARFCN but are general and can be applied to other radio access technologies.

There are systems based on the LTE, operating in licensed, unlicensed and/or shared spectrum, Unlicensed bands offer the possibility for deployment of radio networks by non-traditional operators that do not have access to licensed spectrum, such as e.g. building owners, industrial site and municipalities who want to offer a service within the operation they control. Recently, the LTE standard has been evolved to operate in unlicensed bands for the sake of providing mobile broadband using unlicensed spectrum. The 3GPP based feature of License Assisted Access (LAA) was introduced in Rel. 13, supporting carrier aggregation between a primary carrier in licensed bands, and one or several secondary carriers in unlicensed bands. Further evolution of the LAA feature, which only supports DL traffic, was specified within the Rel. 14 feature of enhanced License Assisted Access (eLAA), which added the possibility to also schedule uplink traffic on the secondary carriers. In parallel to the work within 3GPP Rel. 14, work within the MulteFire Alliance (MFA) aimed to standardize a system that would allow the use of standalone primary carriers within unlicensed spectrum. The resulting MulteFire 1.0 standard supports both UL and DL traffic. Similar issues as discussed above are believed to occur in other systems taking benefit of unlicensed spectrum.

This disclosure proposes how a UE can discover new frequencies, and also expand its list of valid frequencies. It further discloses how a network node may support and/or facilitate this.

It is suggested that the UE examines additional frequencies, e.g. when configured via dedicated RRC signalling or reading broadcast information. The UE compares the configured or observed frequencies with the “valid” frequencies in that band contained in its internal data storage. For example, the additional frequencies may have become “valid” as part of a release of a standard and be used as candidates for carrier frequencies also by UEs compliant to earlier releases. The internally kept valid frequencies according to a particular release of the specification become out dated as new frequencies are introduced in the next release. If the UE discovers that these observed or configured frequencies are not in its list, it adds them to the list. Similar situations may also be caused for other reasons, e.g. that a limited amount of storage space is assigned for pre-storing all thinkable frequencies, e.g. for all regions. Updates and changes for other reasons than release of a standard may cause the same issues.

When the additional frequencies are found to be valid, e.g. through successful operation using them, the additional sets of valid frequencies for a band is utilized in any subsequent cell search in that band and are therefore stored.

As an extension, the UE can independently, i.e. unrelated to any received RRC messages, add new frequencies to its search set, and if valid cells are found add the frequencies to its set of valid frequencies. Such process may be trigged by one or another event, e.g. that one frequency is found valid after an RRC message trigged searching, wherein the UE may autonomously search frequencies close by. Another trigger may be registration to a network with a previously not used country code, etc. The population of a list of frequencies known to at least have been successful may help the UE to keep search time low, limit power consumption by more efficient search, provide more reliable operation and coverage, etc. Since the UE thus is capable of updating itself, better flexibility is reached, and the risk of being outdated due to limited frequency lists is limited.

The frequencies that UE should search for cell discovery in unlicensed bands may be a pre-stored set of EARFCNs to keep the initial cell search time low. Due to deployment considerations e.g. limiting leakage to the guard band, the network may setup cells on EARFCNs that are not part of the pre-stored set, e.g. from a newly released EARFCN set, but then UE may not be able to discover them.

A procedure is performed by a wireless communication device, such as the UE discussed above, which is arranged to operate in a cellular communication system. The procedure involves acquiring information about a carrier frequency to perform measurements on, and checking whether the carrier frequency belongs to a set of frequencies on which information is kept by the wireless communication device in a searchable frequency set. Here, the procedure above may be that the UE receives the carrier frequency from a remote entity, e.g. through an RRC message from a network node or other interaction with the network, and then checks whether it is a “new” frequency. It may as well be that the UE autonomously “checks” first if there is a “new” frequency that is likely to be usable, and then acquires information about it, which may be made locally in the UE or by interaction with other entities, and possibly making a re-check if the new frequency is feasible or suitable. Thus, the steps of acquiring and checking may be performed in sequence, but in any order, or be interleaved in time.

If the carrier frequency belongs to the set, i.e. the frequency is not new, the wireless communication device carries on with measurements as ordinary. However, if the carrier frequency does not belong to the set, the wireless communication device proceeds with including the new frequency to the set. Here, the inclusion may not always be instantly successful in sense of that measurements may not instantly give usable results. For example, the frequency may not be used by a network node in vicinity of the UE where the UE is located at the moment. Another example is that the frequency may not be a true valid frequency. For this case, optionally the UE may be trying to make measurements on the carrier frequency, wherein the wireless communication device adds the information about the carrier frequency to the set only when successful measurements are feasible on the carrier frequency.

The information about the carrier frequency may be a simple identifier or a more complex information set. For example, the information may comprise an absolute radio-frequency channel number, ARFCN, according to a reference of the cellular communication system. For example, the cellular communication system is a 3^{rd} Partnership Project, 3GPP, Long Term Evolution, LTE, system applying enhanced universal terrestrial radio access, EUTRA, and the ARFCN is an EUTRA ARFCN, EARFCN, for a radio band currently applied. For other systems, a corresponding identifier may be used.

As discussed above, it may be desirable that the UE only adds valid frequencies to the set. For this purpose, the UE may do some analysis of the new carrier frequency, e.g. including evaluating whether the information about the carrier frequency is sufficient for the wireless communication device to determine a physical frequency corresponding to the carrier frequency, wherein the wireless communication device interacts through signalling with a serving network node of the cellular communication system to acquire further information about the carrier frequency if the physical frequency cannot be determined.

The searchable frequency set may for example be kept in a list or database. The list or database may be stored in the wireless communication device or a subscriber identity module associated with the wireless communication device. The list or database will through the procedure demonstrated above be further populated upon adding the information about the carrier frequency. If the storage space is limiting, i.e. the memory becomes full, there may be provided a mechanism for pruning the list, where for example frequencies that have never been used, e.g. due to not fitting with the usage of the particular UE, may be pruned. There may be tags associated to stored frequencies in the set which indicates if they are allowed for pruning or not. Further, some stored frequencies may be associated with a timer or counter which may trigger pruning.

The network may assume that UEs update their sets of carrier frequencies, wherein the network is using any carrier frequency when providing for example an RRC message. However, the network may not assume that the solution above is used by all UEs, wherein the network needs to keep track of capabilities of the served UEs. For this purpose, the UE may report, periodically or on request, its capabilities in sense of the frequency set. The reporting may for example include information related to added frequencies. The reporting may also be indirect, i.e. when a network node receives a measurement report related to an added frequency, the network is able to update its knowledge about the capabilities of the UE accordingly.

Other situations where the UE may acquire information about new frequencies are for example at neighbour frequency measurement configurations via system information or measurement objects in dedicated signalling, from secondary cell configurations, mobility control information, or at connection release with a redirect instruction to another frequency. Still other ways for the UE to become aware of other frequencies may comprise other ways than from network node signalling, e.g. via access network discovery and selection function, via other connections, e.g. via the Internet, to an operator or operator services, or through update/exchange of subscriber identity module associated with the UE.

The network node may also inform the UE about carrier frequencies that are new, e.g. recently updated at the network node side, for example due to newly released carrier frequencies in an unlicensed band, newly available carrier frequencies in a licensed band due to agreements or allotment, etc., or based on the network node knowing the set of frequencies at the particular UE to lack some carrier frequencies that are potentially usable in the area or vicinity. The UE will thus also in this way be able to acquire information about carrier frequencies as demonstrated above.

The updated set of frequencies, which may comprise one or more subsets of frequencies, is applied upon performing measurements for keeping mobility and/or service on par. The respective frequencies may belong to a subset based on at least one of operator information, location information, positioning, surrounding radio environment and UE connection history, wherein the subset to be prioritised for performing the measurements is based on corresponding actual circumstances as the division among the subsets. For example, the subsets are divided based on location information, wherein a subset for corresponding location to what the UE can determine, e.g. from country information in signalling from the network node, is used for picking frequencies to be prioritised for measurements. Combinations of the parameters demonstrated above are also feasible, e.g. operator information and UE connection history.

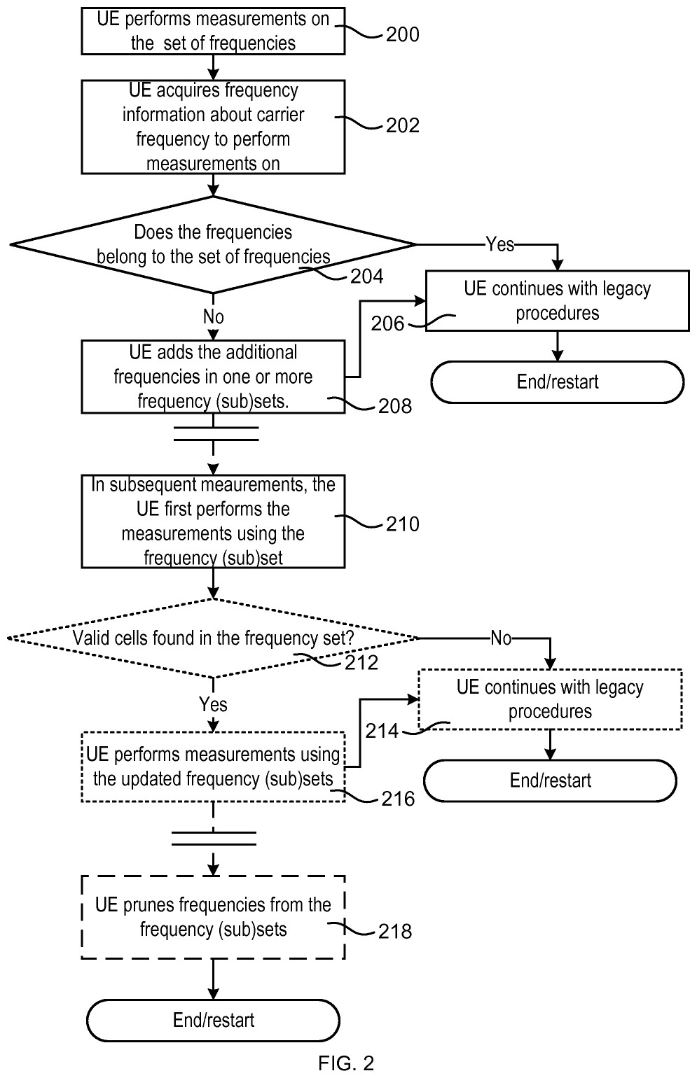

FIG. 2 is a flow chart illustrating methods according to embodiments. The wireless communication device, i.e. UE, performs 200 measurements, e.g. for cell search, on frequencies picked from a set of frequencies. The UE acquires 202, e.g. by receiving a radio resource control message from a network node, information about one or more carrier frequencies on which measurements should be made. The UE checks 204 whether the acquired frequencies belong to the set. If they do, the UE proceeds 206 with the legacy procedures. If a frequency is new, the UE adds 208 the frequency to the set. The frequency may be added to a subset and/or be tagged as an updated frequency, which for example may be used for optional actions, e.g. as step 218 demonstrated below.

The UE now has an updated set of frequencies, which provides one or more of the benefits demonstrated above. Thus, the UE is capable of using the updated frequency set for performing 210 measurements. This also provides a possibility to verify 212 that an added frequency is valid, i.e. by checking if measurements on the added frequency is feasible. If no measurements seem feasible, say after a predetermined number of attempts, the UE may continue 214 without considering the added frequency. If the measurements seem successful on the added frequency, the UE keeps performing measurements including the added frequency. Possibly, the added frequency may be tagged in the set of frequencies as valid.

As discussed above, the frequency set may be desired to be kept reasonably small, e.g. to save storage space and/or to prioritise working frequencies for improved measurements in sense of speed and/or power consumption due to less measurements needed. Therefore, an option is to prune 218 the frequency set by removing one or more frequencies therefrom. Different approaches for finding which frequencies to remove, and which not (never) to remove have been discussed above.

FIG. 3 is a block diagram schematically illustrating a UE 300 according to an embodiment. The UE comprises an antenna arrangement 302, a receiver 304 connected to the antenna arrangement 302, a transmitter 306 connected to the antenna arrangement 302, a processing element 308 which may comprise one or more circuits, one or more input interfaces 310 and one or more output interfaces 312. The interfaces 310, 312 can be user interfaces and/or signal interfaces, e.g. electrical or optical. The UE 300 is arranged to operate in a cellular communication network. In particular, by the processing element 308 being arranged to perform the embodiments demonstrated with reference to FIG. 2, the UE 300 is capable of updating a set of frequencies on which measurements are supposed to be made, e.g. for cell search. The processing element 308 can also fulfil a multitude of tasks, ranging from signal processing to enable reception and transmission since it is connected to the receiver 304 and transmitter 306, executing applications, controlling the interfaces 310, 312, etc.

The methods according to the present disclosure are suitable for implementation with aid of processing means, such as computers and/or processors, especially for the case where the processing element 308 demonstrated above comprises a processor handling the updating of the set of frequencies. Therefore, there is provided computer programs, comprising instructions arranged to cause the processing means, processor, or computer to perform the steps of any of the methods according to any of the embodiments described with reference to FIG. 2. The computer programs preferably comprise program code which is stored on a computer readable medium 400, as illustrated in FIG. 4, which can be loaded and executed by a processing means, processor, or computer 402 to cause it to perform the methods, respectively, according to embodiments of the present disclosure, preferably as any of the embodiments described with reference to FIG. 2. The computer 402 and computer program product 400 can be arranged to execute the program code sequentially where actions of the any of the methods are performed stepwise. The processing means, processor, or computer 402 is preferably what normally is referred to as an embedded system. Thus, the depicted computer readable medium 400 and computer 402 in FIG. 4 should be construed to be for illustrative purposes only to provide understanding of the principle, and not to be construed as any direct illustration of the elements.

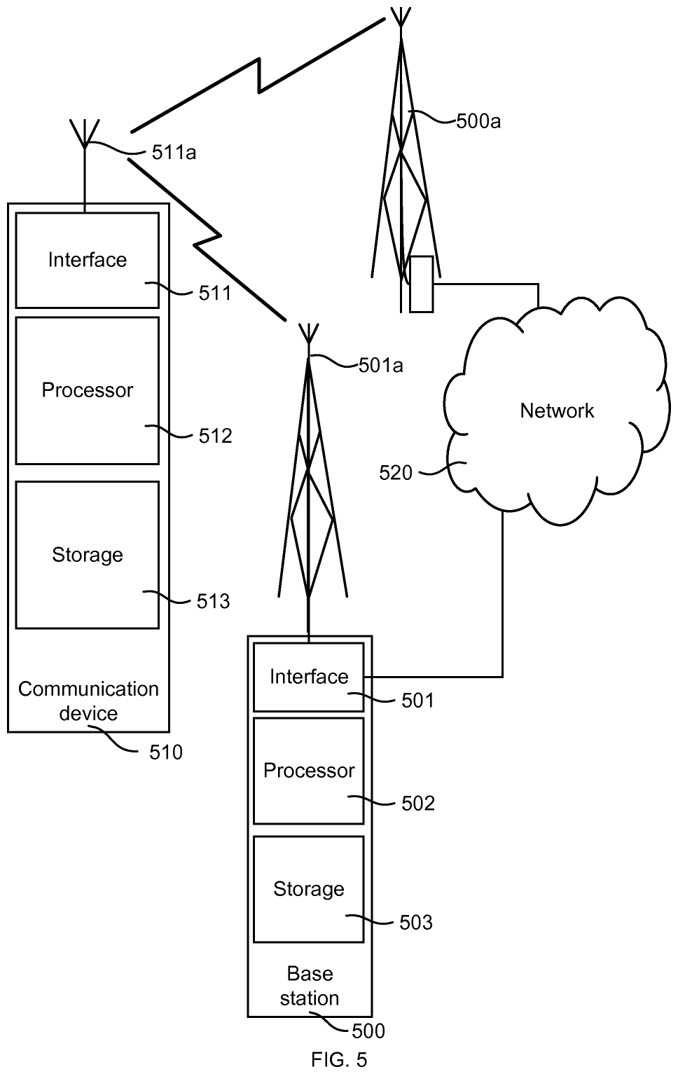

FIG. 5 illustrates a wireless network comprising NW nodes 500 and 500a and a wireless device 510 with a more detailed view of the network node 500 and the communication device 510 in accordance with an embodiment. For simplicity, FIG. 5 only depicts core network 520, network nodes 500 and 500a, and communication device 510. Network node 500 comprises a processor 502, storage 503, interface 501, and antenna 501a. Similarly, the communication device 510 comprises a processor 512, storage 513, interface 511 and antenna 511a. These components may work together in order to provide network node and/or wireless device functionality as demonstrated above. In different embodiments, the wireless network may comprise any number of wired or wireless networks, network nodes, base stations, controllers, wireless devices, relay stations, and/or any other components that may facilitate or participate in the communication of data and/or signals whether via wired or wireless connections.

The network 520 may comprise one or more IP networks, public switched telephone networks (PSTNs), packet data networks, optical networks, wide area networks (WANs), local area networks (LANs), wireless local area networks (WLANs), public land mobile networks (PLMNs), wired networks, wireless networks, metropolitan area networks, and other networks to enable communication between devices. The network 520 may comprise a network node for performing the method demonstrated with reference to FIG. 6, and/or an interface for signalling between network nodes 500, 500a.

FIG. 6 is a flow chart schematically illustrating a method performed by the network node 500, 500a. The network node transmits 600 information to the wireless device 510 about carrier frequencies on which the wireless device 510 should make measurements. As demonstrated above, the wireless device may be successful with performing the measurements on the new frequency, wherein the network node receives 602 a measurement report. However, if the wireless device for example is not able to find out the physical frequency corresponding to for example the indication of the new frequency, such as EARFCN, the wireless device may request additional information from the network node. The network node does in such cases receive 604 a request for further information about the new carrier frequency. The request may be direct, i.e. through a protocol for the request of the information, or indirect, such as a non-acknowledgement of the received indicator or an error message related to the measurements. In any case, the network node is arranged to identify that the wireless device needs further information, and may provide that, e.g. through signalling or interaction on a higher level protocol with the wireless device.

The network node 500 comprises a processor 502, storage 503, interface 501, and antenna 501a. These components are depicted as single boxes located within a single larger box. In practice however, a network node may comprise multiple different physical components that make up a single illustrated component (e.g., interface 501 may comprise terminals for coupling wires for a wired connection and a radio transceiver for a wireless connection). Similarly, network node 500 may be composed of multiple physically separate components (e.g., a NodeB component and a radio network controller (RNC) component, a base transceiver station (BTS) component and a base station controller (BSC) component, etc.), which may each have their own respective processor, storage, and interface components. In certain scenarios in which network node 500 comprises multiple separate components (e.g., BTS and BSC components), one or more of the separate components may be shared among several network nodes. For example, a single RNC may control multiple NodeBs. In such a scenario, each unique NodeB and BSC pair, may be a separate network node. In some embodiments, network node 500 may be configured to support multiple radio access technologies (RATs). In such embodiments, some components may be duplicated (e.g., separate storage 503 for the different RATs) and some components may be reused (e.g., the same antenna 501a may be shared by the RATs).

The processor 502 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in conjunction with other network node 500 components, such as storage 503, network node 500 functionality. For example, processor 502 may execute instructions stored in storage 503. Such functionality may include providing various wireless features discussed herein to a wireless communication device, such as the wireless device 510, including any of the features or benefits disclosed herein.

Storage 503 may comprise any form of volatile or non-volatile computer readable memory including, without limitation, persistent storage, solid state memory, remotely mounted memory, magnetic media, optical media, random access memory (RAM), read-only memory (ROM), removable media, or any other suitable local or remote memory component. Storage 503 may store any suitable instructions, data or information, including software and encoded logic, utilized by the network node 500. the storage 503 may be used to store any calculations made by the processor 502 and/or any data received via the interface 501.

The network node 500 also comprises the interface 501 which may be used in the wired or wireless communication of signalling and/or data between network node 500, network 520, and/or wireless device 510. For example, the interface 501 may perform any formatting, coding, or translating that may be needed to allow network node 500 to send and receive data from the network 520 over a wired connection. The interface 501 may also include a radio transmitter and/or receiver that may be coupled to or a part of the antenna 501a. The radio may receive digital data that is to be sent out to other network nodes or wireless devices via a wireless connection. The radio may convert the digital data into a radio signal having the appropriate channel and bandwidth parameters. The radio signal may then be transmitted via antenna 501a to the appropriate recipient (e.g., the wireless device 510).

The antenna 501a may be any type of antenna capable of transmitting and receiving data and/or signals wirelessly. In some embodiments, antenna 501a may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. The antenna 501a may comprise one or more elements for enabling different ranks of SIMO, MISO or MIMO operation, or beamforming operations.

The wireless device 510 may be any type of communication device, wireless device, UE, D2D device or ProSe UE, but may in general be any device, sensor, smart phone, modem, laptop, Personal Digital Assistant (PDA), tablet, mobile terminal, smart phone, laptop embedded equipped (LEE), laptop mounted equipment (LME), Universal Serial Bus (USB) dongles, machine type UE, UE capable of machine to machine (M2M) communication, etc., which is able to wirelessly send and receive data and/or signals to and from a network node, such as network node 500 and/or other wireless devices. The wireless device 510 comprises a processor 512, storage 513, interface 511, and antenna 511a. Like the network node 500, the components of the wireless device 510 are depicted as single boxes located within a single larger box, however in practice a wireless device may comprises multiple different physical components that make up a single illustrated component (e.g., storage 513 may comprise multiple discrete microchips, each microchip representing a portion of the total storage capacity).

The processor 512 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in combination with other wireless device 510 components, such as storage 513, wireless device 510 functionality. Such functionality may include providing various wireless features discussed herein, including any of the features or benefits disclosed herein.

The storage 513 may be any form of volatile or non-volatile memory including, without limitation, persistent storage, solid state memory, remotely mounted memory, magnetic media, optical media, random access memory (RAM), read-only memory (ROM), removable media, or any other suitable local or remote memory component. The storage 513 may store any suitable data, instructions, or information, including software and encoded logic, utilized by the wireless device 510. The storage 513 may be used to store any calculations made by the processor 512 and/or any data received via the interface 511.

The interface 511 may be used in the wireless communication of signalling and/or data between the wireless device 510 and the network nodes 500, 500a. For example, the interface 511 may perform any formatting, coding, or translating that may be needed to allow the wireless device 510 to send and receive data to/from the network nodes 500, 500a over a wireless connection. The interface 511 may also include a radio transmitter and/or receiver that may be coupled to or a part of the antenna 511a. The radio may receive digital data that is to be sent out to e.g. the network node 501 via a wireless connection. The radio may convert the digital data into a radio signal having the appropriate channel and bandwidth parameters. The radio signal may then be transmitted via the antenna 511a to e.g. the network node 500.

The antenna 511a may be any type of antenna capable of transmitting and receiving data and/or signals wirelessly. In some embodiments, antenna 511a may comprise one or more omni-directional, sector or panel antennas operable to transmit/receive radio signals between 2 GHz and 66 GHz. For simplicity, antenna 511a may be considered a part of interface 511 to the extent that a wireless signal is being used. The antenna 511a may comprise one or more elements for enabling different ranks of SIMO, MISO or MIMO operation, or beamforming operations.

In some embodiments, the components described above may be used to implement one or more functional modules used for enabling measurements as demonstrated above. The functional modules may comprise software, computer programs, sub-routines, libraries, source code, or any other form of executable instructions that are run by, for example, a processor. In general terms, each functional module may be implemented in hardware and/or in software. Preferably, one or more or all functional modules may be implemented by the processors 512 and/or 502, possibly in cooperation with the storage 513 and/or 503. The processors 512 and/or 502 and the storage 513 and/or 503 may thus be arranged to allow the processors 512 and/or 502 to fetch instructions from the storage 513 and/or 503 and execute the fetched instructions to allow the respective functional module to perform any features or functions disclosed herein. The modules may further be configured to perform other functions or steps not explicitly described herein but which would be within the knowledge of a person skilled in the art.

Certain aspects of the inventive concept have mainly been described above with reference to a few embodiments. However, as is readily appreciated by a person skilled in the art, embodiments other than the ones disclosed above are equally possible and within the scope of the inventive concept. Similarly, while a number of different combinations have been discussed, all possible combinations have not been disclosed. One skilled in the art would appreciate that other combinations exist and are within the scope of the inventive concept. Moreover, as is understood by the skilled person, the herein disclosed embodiments are as such applicable also to other standards and communication systems and any feature from a particular figure disclosed in connection with other features may be applicable to any other figure and or combined with different features.

1. A method performed by a wireless communication device configured to operate in a cellular communication system, the method comprising
acquiring information about a carrier frequency to perform measurements on;
checking whether the carrier frequency belongs to a set of frequencies on which information is kept by the wireless communication device in a searchable frequency set; and:
if the carrier frequency belongs to the set, the wireless communication device carries on with measurements; and
if the carrier frequency does not belong to the set, the wireless communication device proceeds with adding the information about the carrier frequency to the set.

2. The method of claim 1, further comprising trying to make measurements on the carrier frequency, wherein the wireless communication device only adds the information about the carrier frequency to the set when successful measurements are feasible on the carrier frequency.

3. The method of claim 1, wherein the information about the carrier frequency comprises an absolute radio-frequency channel number, ARFCN, according to a reference of the cellular communication system.

4. The method of claim 3, wherein the cellular communication system is one of a 3^{rd} Generation Partnership Project, 3GPP, Long Term Evolution, LTE, system, and a system based on thereon, operating in one of a licensed, unlicensed and shared spectrum applying enhanced universal terrestrial radio access, EUTRA, and the ARFCN is an EUTRA ARFCN, EARFCN, for a radio band currently applied.

5. The method of claim 1, further comprising:
evaluating whether the information about the carrier frequency is sufficient for the wireless communication device to determine a physical frequency corresponding to the carrier frequency, wherein the wireless communication device interacts through signalling with a serving network node of the cellular communication system to acquire further information about the carrier frequency if the physical frequency cannot be determined.

6. The method of claim 1, wherein the searchable frequency set is kept in one of a list in the wireless communication device, a database in the wireless communication device and a subscriber identity module associated with the wireless communication device, which one of the list and the database is further populated upon adding the information about the carrier frequency.

7. The method of claim 1, wherein the acquiring of the information about the carrier frequency includes receiving signalling comprising the information from a serving network node of the cellular communication system.

8. The method of claim 1, wherein the set of frequencies comprises at least one subset of frequencies, where the respective frequencies belong to a subset based on at least one of operator information, location information, positioning, surrounding radio environment and UE connection history, wherein the subset to be prioritised for performing the measurements is based on corresponding actual circumstances as the division among the subsets.

9. A computer storage medium storing a computer program comprising instructions which, when executed on a processor of a wireless communication device, causes the wireless communication device to perform a method comprising:
acquiring information about a carrier frequency to perform measurements on;
checking whether the carrier frequency belongs to a set of frequencies on which information is kept by the wireless communication device in a searchable frequency set; and:
if the carrier frequency belongs to the set, the wireless communication device carries on with measurements; and
if the carrier frequency does not belong to the set, the wireless communication device proceeds with adding the information about the carrier frequency to the set.

10. A wireless communication device arranged configured to operate in a cellular communication system, the wireless communication device comprising a transceiver, a processor and a memory and being configured to:
acquire information about a carrier frequency to perform measurements on;
check whether the carrier frequency belongs to a set of frequencies on which information is kept by the wireless communication device in a searchable frequency set; and:
if the carrier frequency belongs to the set, the wireless communication device carries on with measurements; and
if the carrier frequency does not belong to the set, the wireless communication device proceeds with adding the information about the carrier frequency to the set.

11. A method performed by a network node configured to operate in a cellular communication system, the method comprising:
transmitting information about a carrier frequency to a wireless communication device on which the wireless communication device is intended to perform measurements on; and
one of:
receiving a measurement report related to the carrier frequency from the wireless communication device; and
receiving a request from the wireless communication device for further information about the carrier frequency.

12. The method of claim 11, wherein the information about the carrier frequency comprises an absolute radio-frequency channel number, ARFCN, according to a reference of the cellular communication system.

13. The method of claim 12, wherein the cellular communication system is one of a 3^{rd} Generation Partnership Project, 3GPP, Long Term Evolution, LTE, system, and a system based on thereon, operating in one of a licensed, unlicensed and shared spectrum applying enhanced universal terrestrial radio access, EUTRA, and the ARFCN is an EUTRA ARFCN, EARFCN, for a radio band currently applied.

14. A computer storage medium storing a computer program comprising instructions which, when executed on a processor of a network node, causes the network node to perform a method comprising:
transmitting information about a carrier frequency to a wireless communication device on which the wireless communication device is intended to perform measurements on; and
one of:
receiving a measurement report related to the carrier frequency from the wireless communication device; and
receiving a request from the wireless communication device for further information about the carrier frequency.

15. A network node configured to operate in a cellular communication system, the network node comprising a transceiver, a processor and a memory and being arranged configured to:
transmit information about a carrier frequency to a wireless communication device on which the wireless communication device is intended to perform measurements on; and
one of:
receive a measurement report related to the carrier frequency from the wireless communication device; and
receive a request from the wireless communication device for further information about the carrier frequency.

16. The method of claim 2, wherein the information about the carrier frequency comprises an absolute radio-frequency channel number, ARFCN, according to a reference of the cellular communication system.

17. The wireless communication device of claim 10, wherein the wireless communication device is further configured to try to make measurements on the carrier frequency, wherein the wireless communication device only adds the information about the carrier frequency to the set when successful measurements are feasible on the carrier frequency

18. The wireless communication device of claim 17, wherein the cellular communication system is one of a 3^{rd} Generation Partnership Project, 3GPP, Long Term Evolution, LTE, system, and a system based on thereon, operating in one of a licensed, unlicensed and shared spectrum applying enhanced universal terrestrial radio access, EUTRA, and the ARFCN is an EUTRA ARFCN, EARFCN, for a radio band currently applied.

19. The wireless communication device of claim 10, wherein the wireless communication device is further configured evaluate whether the information about the carrier frequency is sufficient for the wireless communication device to determine a physical frequency corresponding to the carrier frequency, wherein the wireless communication device interacts through signalling with a serving network node of the cellular communication system to acquire further information about the carrier frequency if the physical frequency cannot be determined.

20. The wireless communication device of claim 10, wherein the searchable frequency set is kept in one of a list in the wireless communication device, a database in the wireless communication device and a subscriber identity module associated with the wireless communication device, which one of the list and the database is further populated upon adding the information about the carrier frequency.
